(19) United States
(12) Patent Application Publication
(10) Pub. No.: US 2026/0351197 A1
(43) Pub. Date: Nov. 5, 2026

(54) Display Panel and Display Apparatus

(71) Applicant: LG Display Co., Ltd., Seoul (KR)

(72) Inventors: Binn Kim, Paju-si (KR); Chang Soo Kim, Paju-si (KR); Eui Tae Kim, Paju-si (KR)

(21) Appl. No.: 19/662,439

(22) Filed: Apr. 29, 2026

(30) Foreign Application Priority Data
Apr. 30, 2025 (KR) 10-2025-0057148

(51) Int. Cl. G09G 3/3266; G09G 3/3291

(52) U.S. Cl. CPC G09G 3/3266; G09G 3/3291; G09G 2310/0286; G09G 2320/0233

(57) ABSTRACT

A display panel presented herein includes an active area including a plurality of pixel areas and a plurality of circuit areas, a subpixel configured to receive a data voltage to allow a light-emitting device to emit light, based on a first scan signal supplied through a first gate line, and a plurality of first scan blocks distributed and disposed in the active area. Each first scan block includes a first scan circuit disposed in a plurality of first circuit areas and configured to generate the first scan signal to supply the first scan signal to the first gate line. The active area includes a notch area where a portion thereof is recessed. The plurality of first gate lines include a plurality of first side gate lines and a plurality of first upper gate lines. The plurality of first upper gate lines include a plurality of open circuit portions.

### CROSS-REFERENCE TO RELATED APPLICATION

The present application claims priority to Republic of Korean Patent Application No. 10-2025-0057148, filed on Apr. 30, 2025, which is hereby incorporated by reference in its entirety.

### BACKGROUND

### Field

The present disclosure relates to a display panel and a display apparatus.

### Discussion of Related Art

As the information society advances, the demands for display apparatuses for displaying an image are increasing in various forms. Recently, various flat display apparatuses such as electroluminescent display apparatuses including organic light emitting diode (OLED) display apparatuses, quantum dot light emitting diode (QLED) display apparatuses, and micro light emitting diode (micro-LED) display apparatuses are being used.

Recently, in such various display apparatuses, automotive display apparatuses equipped in vehicles are being variously developed. Display panels applied to automotive display apparatuses may have a shape where a length in a horizontal direction is far greater than a length in a vertical direction, due to a limitation of a space.

Therefore, display panels applied to automotive display apparatuses may include circuits which may supply a scan signal to the display panel and may be distributed and disposed in a plurality of circuit areas.

Furthermore, considering instrument panels such as speedometers and fuel gauges in vehicles, display panels of automotive display apparatuses may include a notch portion where a portion of a display panel is recessed inward.

### SUMMARY

To overcome the aforementioned problem of the related art, the present disclosure may provide a display panel and a display apparatus, which may enhance the quality of an image displayed thereon even when a notch area is provided therein.

To achieve these objects and other advantages and in accordance with the purpose of the disclosure, as embodied and broadly described herein, a display panel includes an active area including a plurality of pixel areas arranged spaced apart from each other in a first direction and a plurality of circuit areas arranged between the plurality of pixel areas, a subpixel disposed in each of the plurality of pixel areas and configured to receive a data voltage to allow a light-emitting device to emit light, based on a first scan signal supplied through a first gate line extending in the first direction, and a plurality of first scan blocks distributed and disposed in the active area and each including a first scan circuit disposed in a plurality of first circuit areas among the plurality of circuit areas and configured to generate the first scan signal to supply the first scan signal to the first gate line, wherein the active area includes a notch area where a portion thereof is recessed in a second direction intersecting with the first direction, the plurality of first gate lines include a plurality of first side gate lines disposed on a side surface of the notch area in the first direction and each including an end contacting the notch area and a plurality of first upper gate lines disposed on the notch area in the second direction, and the plurality of first upper gate lines comprise a plurality of open circuit portions where a portion of a first upper gate line is disconnected and opened.

In one or more other embodiments of the present disclosure, a display apparatus includes an active area including a plurality of pixel areas arranged spaced apart from each other in a first direction and a plurality of circuit areas arranged between the plurality of pixel areas, a subpixel disposed in each of the plurality of pixel areas and configured to receive a data voltage to allow a light-emitting device to emit light, based on a first scan signal supplied through a first gate line extending in the first direction, and a plurality of first scan blocks distributed and disposed in the active area and each including a first scan circuit disposed in a plurality of first circuit areas among the plurality of circuit areas and configured generate the first scan signal to supply the first scan signal to the first gate line, wherein the active area includes a notch area where a portion of the active area is recessed in a second direction intersecting with the first direction, the plurality of first gate lines include a plurality of first side gate lines disposed on a side surface of the notch area in the first direction and each including an end contacting the notch area and a plurality of first upper gate lines disposed on the notch area in the second direction, and each of the plurality of first upper gate lines includes a plurality of open circuit portions where a portion of a first upper gate line is disconnected and opened and open-circuited ends of the first upper gate line are spaced apart from each other in the first direction.

When a display panel includes a notch area, embodiments of the present disclosure may include an open circuit portion where a portion of a first upper gate line is disconnected and opened , and thus, may improve a luminance deviation between a side surface and an upper portion of the notch area in an active area, thereby enhancing the quality of a display screen.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram schematically illustrating a display apparatus according to one or more embodiments of the present disclosure.

FIG. 2 is an enlarged view of a K1 portion in FIG. 1.

FIG. 3 is an example of an equivalent circuit of a subpixel included in a pixel area of FIG. 2.

FIG. 4 is an example of a cross-sectional view for describing a cross-sectional structure of a subpixel according to one or more embodiments of the present disclosure.

FIG. 5 is a diagram for describing a configuration of a shift register included in a gate driver of FIG. 2.

FIG. 6 schematically illustrates an arrangement structure of first, second, and third scan blocks included in a display panel according to one or more embodiments of the present disclosure.

FIG. 7 is an enlarged view of a K2 portion in FIG. 6.

FIG. 8 is an enlarged view of a K3 portion in FIG. 6 so as to describe in more detail an open circuit portion included in each of a first gate line and first and second blocks of a first scan block.

FIG. 9 is a diagram for describing a configuration of each of first and second scan circuits according to one or more embodiments of the present disclosure.

FIG. 10 is a diagram for describing an example where the first and second scan circuits of FIG. 9 are applied to a plurality of first and second circuit areas.

FIG. 11 is a diagram for describing an example of an EM circuit illustrated in FIG. 7.

FIG. 12 is a diagram for describing an example where the EM circuit of FIG. 11 is applied to a plurality of third circuit areas.

FIG. 13 is an enlarged view of a K4 portion in FIG. 8.

FIG. 14 is a cross-sectional view illustrating a cross-sectional surface taken along line CS-CS' in FIG. 13.

FIGS. 15A and 15B are diagrams for describing an effect based on an open circuit portion according to one or more embodiments of the present disclosure.

### DETAILED DESCRIPTION

Hereinafter, embodiments of the present disclosure will be described in detail with reference to the accompanying drawings. In the disclosure, in adding reference numerals for elements in each drawing, it should be noted that like reference numerals already used to denote like elements in other drawings are used for elements wherever possible. In the following description, when the detailed description of the relevant known function or configuration is determined to unnecessarily obscure the important point of the present disclosure, the detailed description will be omitted.

Like reference numerals refer to like elements. Also, a thickness, a ratio, and a dimension of each element described herein are illustrated to be partially enlarged or reduced for convenience of effective description. A scale of each element illustrated in the drawings of the present disclosure may have a scale which differs from a real scale, for convenience of description, but is not limited to a scale illustrated in the drawings.

In the present disclosure, when an arbitrary element (or a region, a layer, a portion, etc.) is described as “being on”, "connected", or "coupled", this may denote that the arbitrary element may be directly connected/coupled to another element, or a third element may be disposed therebetween.

The term "and/or" may include all of one or more combinations capable of being defined by relevant elements.

Terms like a first and a second may be used to describe various elements, but the elements should not be limited by the terms. The terms may be used only as object for distinguishing an element from another element. For example, without departing from the spirit and scope of the inventive concept, a first element may be referred to as a second element, and similarly, the second element may be referred to as the first element. The terms of a singular form may include plural forms unless referred to the contrary.

The terms "under", "below", "on", and "above" may be used to describe a correlation between elements illustrated in the drawings. The terms may be a relative concept and may be described with respect to a direction illustrated in the drawings. For example, unless "just" or "direct" is used, one or more other elements between two elements may be disposed. Spatially relative terms “below”, “beneath”, “lower”, “above”, and “upper” may be used herein for easily describing a relationship between one device or elements and other devices or elements as illustrated in the drawings. Therefore, for example, "under” and "lower" may be opposite to "on" and "upper" with respect to a first element.

It should be understood that spatially relative terms are terms including different orientations of elements in use or operation, in addition to the orientation illustrated in the drawings. For example, if a device in the drawings is turned over, elements described as being on the “below” or “beneath” sides of other elements may be placed on “above” sides of the other elements. Therefore, the exemplary term “lower” may include both orientations of “lower” and “upper”. Likewise, the exemplary term “above” or “upper” may include both orientations of above and below.

It should be understood that the meaning of “include,” “comprise,” “including,” or “comprising,” specifies a property, a region, a fixed number, a step, a process, an element and/or a component, but does not exclude other properties, regions, fixed numbers, steps, processes, elements and/or components.

Features of various embodiments of the present disclosure may be partially or overall coupled to or combined with each other and may be variously inter-operated with each other and driven technically as those skilled in the art can sufficiently understand. The embodiments of the present disclosure may be carried out independently of each other, or may be carried out together in co-dependent relationship.

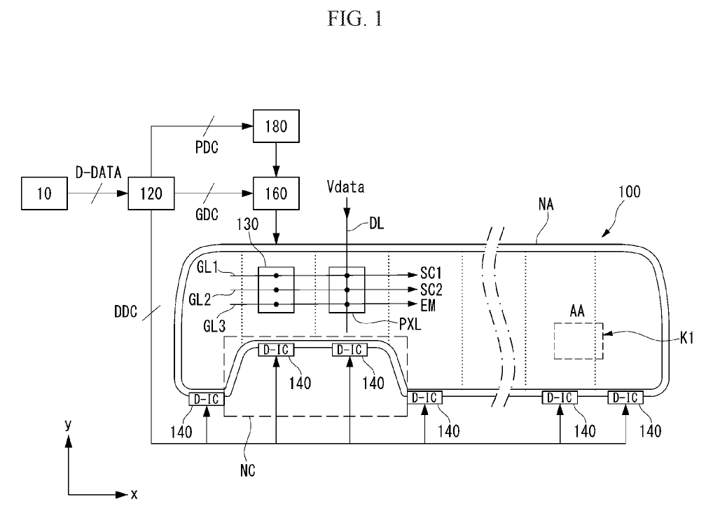

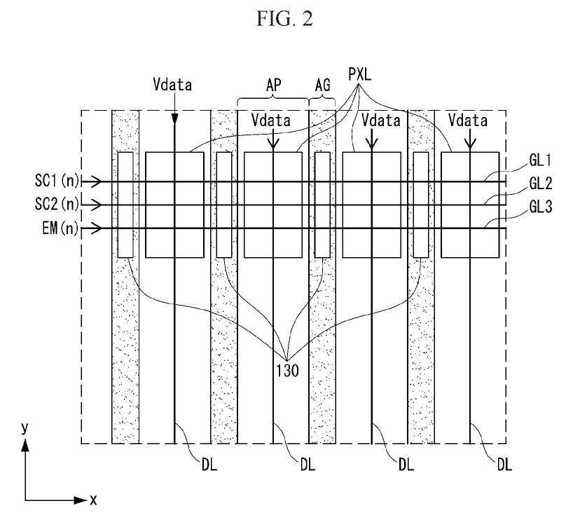

FIG. 1 is a block diagram schematically illustrating a display apparatus according to one or more embodiments of the present disclosure, and FIG. 2 is an enlarged view of a K1 portion in FIG. 1.

As illustrated in FIG. 1, a display apparatus according to one or more embodiments of the present disclosure may include a display panel 100, a timing controller 120, a gate driver 130, a data driver 140, a power supply circuit 180, and a subpixel PXL.

As illustrated in FIG. 1, the display panel 100 may include an active area AA and a non-active area NA. The non-active area NA may be disposed along an edge of the display panel 100 and may be disposed outside the active area AA in the display panel 100.

The active area AA may display an image based on an image signal, and the non-active area NA may form a bezel area of the display panel 100 which does not display an image. The active area AA may include a plurality of pixel areas AP and a plurality of circuit areas AG.

As in FIG. 1, the gate driver 130 and the subpixel PXL may be disposed in the active area AA. In FIG. 1, for convenience of understanding, one gate driver 130 and one subpixel PXL are illustrated as an example, but are not limited thereto and each subpixel PXL may be disposed in each pixel area AP, and the gate driver 130 may be distributed and disposed in each circuit area AG.

For example, as illustrated in FIG. 2, the plurality of pixel areas AP and the plurality of circuit areas AG may be alternately arranged in a first direction x (or a horizontal direction), and thus, the plurality of circuit areas AG may be arranged between the plurality of pixel areas AP. Each of the plurality of pixel areas AP and the plurality of circuit areas AG may extend in a second direction y (or a column direction) intersecting with the first direction x.

At least one unit pixel may be disposed in each of the plurality of pixel areas AP. Each unit pixel may be arranged in the first direction x in the plurality of pixel areas AP and may be arranged in the second direction y which is a length direction of each pixel area AP, and thus, may be disposed as a matrix type, thereby forming a pixel array.

Each unit pixel may include a plurality of subpixels PXL. The plurality of subpixels PXL included in each unit pixel may include a red (R) subpixel, a green (G) subpixel, and a blue (B) subpixel, or may include the red (R) subpixel, the green (G) subpixel, the blue (B) subpixel, and a white (W) subpixel.

For example, the red (R) subpixel, the green (G) subpixel, and the blue (B) subpixel included in each unit pixel may implement various colors by controlling a luminance of each subpixel PXL.

Therefore, for example, a plurality of subpixels including the red (R) subpixel, the green (G) subpixel, and the blue (B) subpixel may be disposed in one pixel area AP arranged between two adjacent circuit areas AG.

In FIG. 2, it is illustrated that one subpixel PXL is disposed in each pixel area AP, but this is for convenience of understanding, and at least one unit pixel may be disposed in the first direction x in each pixel area AP. For example, one unit pixel including the plurality of subpixels PXL may be disposed in the first direction x in each pixel area AP, and a plurality of unit pixels may be arranged in the second direction y.

At least one gate lines GL1, GL2, and GL3 extending in the first direction x may intersect with a data line DL extending in the second direction y, in each subpixel PXL of the pixel area AP, and each subpixel PXL may be supplied with a first or second scan signal SC1(n) or SC2(n) or an emission control signal EM(n) through the gate lines GL1, GL2, and GL3 and may be supplied with a data voltage Vdata through the data line DL. Each subpixel PXL may be supplied with the data voltage Vdata according to the first scan signal SC1(n) and may control the light emission of a light-emitting device included in the subpixel PXL according to the emission control signal EM(n).

In FIG. 2, a case where one data line DL and three gate lines GL1, GL2, and GL3 intersect with each other in each subpixel PXL is illustrated as an example. The three gate lines GL1, GL2, and GL3 may include first, second, and third gate lines GL1, GL2, and GL3. However, this may be an example, and the present disclosure is not limited thereto. For example, the second gate line GL2 or the third gate line GL3 may be omitted in FIG. 2. Hereinafter, for convenience of description, one or more embodiments of the present disclosure will be described with reference to FIG. 2.

Each of the gate lines GL1, GL2, and GL3 may extend in the first direction x and may be disposed to overlap the plurality of pixel areas AP and the plurality of circuit areas AG and may be connected to, in common, the subpixels PXL adjacent thereto in the first direction x. Each data line DL may extend in the second direction y along each pixel area AP and may be connected to, in common, the subpixels PXL adjacent thereto in the second direction y.

For example, each data line DL may extend in the second direction y in the pixel area AP and may be electrically connected to a corresponding subpixel PXL among the plurality of subpixels PXL, and each of the gate lines GL1, GL2, and GL3 may extend in the first direction x, may be electrically connected to each subpixel PXL in the pixel area AP, and may be connected to a portion of a desired gate driver 130 in the circuit area AG where a plurality of gate drivers 130 are distributed and disposed.

The first scan signal SC1(n) may be applied to the first gate line GL1, the second scan signal SC2(n) may be applied to the second gate line GL2, and the emission control signal EM(n) may be applied to the third gate line GL3.

The first scan signal SC1(n) may allow control to be performed so that the data voltage Vdata is applied to the subpixel PXL, the second scan signal SC2(n) may allow control to be performed so that a pixel circuit configuring each subpixel PXL is initialized to a reference voltage Vref, and the emission control signal EM(n) may allow control to be performed so that an emission current generated by a driving transistor is to be supplied to a light-emitting device.

The data driver 140 may generate an analog data voltage Vdata and may supply the analog data voltage Vdata to the subpixel PXL connected thereto through the data line DL.

The data driver 140 may convert digital image data, input from the timing controller 120, into the analog data voltage Vdata based on a data timing control signal and may supply the data voltage Vdata to the subpixel PXL through the data line DL. Each data voltage Vdata may have a voltage value corresponding to an image gray level which is to be expressed in each subpixel PXL.

To this end, the data driver 140 may include a data driving integrated circuit (IC) electrically connected to a non-active area NA of the display panel 100.

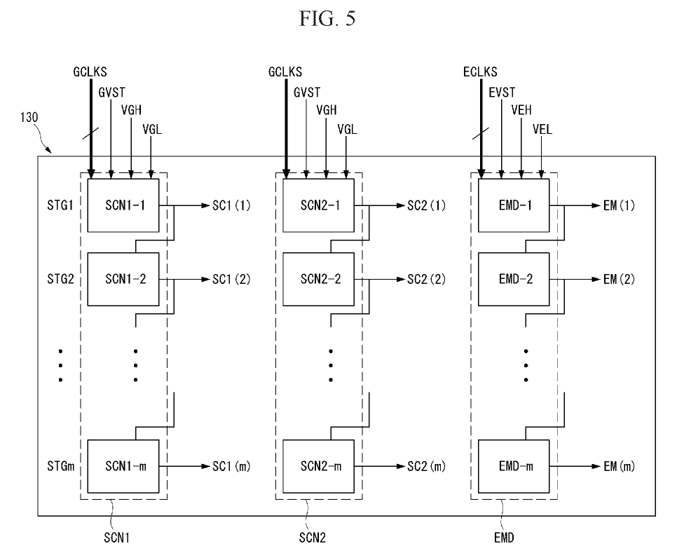

In a case where the subpixel PXL is supplied with gate driving signals GDS1(n) and GDS2(n) and the emission control signal EM(n), the gate driver 130 may include, for example, first and second scan circuits and an EM circuit. Here, the first and second scan circuits and the EM circuit may be distributed and disposed in the plurality of circuit areas AG. The first and second scan circuits and the EM circuit will be described below in detail with reference to FIG. 5.

The first and second scan circuits and the EM circuit of the gate driver 130 may operate based on signals and voltages output from the timing controller 120, the power supply circuit 180, and a level shifter 160. The first and second scan circuits and the EM circuit may output signals through the gate lines GL1, GL2, and GL3 connected to the display panel 100 in response to a gate timing control signal GDC supplied from the timing controller 120. The gate driver 130 may include a shift register for outputting signals. The first and second scan circuits and the EM circuit may be included in the shift register.

The level shifter 160 may receive the gate timing control signal GDC from the timing controller 120 and may convert the gate timing control signal GDC into a level having a turn-on voltage and a turn-off voltage, and a level-converted gate timing signal may be input to the first and second scan circuits and the EM circuit.

The first scan circuit may generate the first scan signal SC1(n) and may supply the first scan signal SC1(n) to the first gate line GL1. The second scan circuit may generate the second scan signal SC2(n) to supply the second scan signal SC2(n) to the second gate line GL2. The EM circuit may generate the emission control signal EM(n) to supply the emission control signal EM(n) to the third gate line GL3.

The EM circuit may receive a voltage of a gate timing control signal from the level shifter 160 to generate the emission control signal EM(n) and may supply the generated emission control signal EM(n) to each subpixel PXL.

The first and second scan circuits may receive the voltage of the gate timing signal from the level shifter 160 to generate the first and second scan signals SC1(n) and SC2(n) and supply the first and second scan signals SC1(n) and SC2(n) to each subpixel PXL.

Each of the first and second scan circuits and the EM circuit may be distributed and disposed in the plurality of circuit areas AG provided in the active area AA. An arrangement structure of the gate driver 130 will be described below in detail with reference to FIG. 5.

The power supply circuit 180 may process an input power according to a power timing control signal PDC input from the timing controller 120 to generate a high-level driving voltage VDD and a low-level driving voltage VSS, which are to be supplied to each subpixel PXL, or may generate gate high voltages VGH and VEH and gate low voltages VGL and VEL, which are to be supplied to transistors included in the first and second scan circuits and the EM circuit.

The timing controller 120 may generate the timing control signals GDC, DDC, and PDC based on digital image data D-DATA input from a host system 10 and may respectively supply the timing control signals GDC, DDC, and PDC to the gate driver 130, data driver 140, and the power supply circuit 180.

The timing controller 120 may temporally divide one frame period into an initialization period, a programming period succeeding the initialization period, and an emission period succeeding the programming period to supply the timing control signals GDC and DDC to the data driver 140 and the gate driver 130.

The host system 10 may supply the digital image data D-DATA to the timing controller 120 and may be a main board such as a television system, a set-top box, a navigation system, a personal computer, and a home theater system, but embodiments of the present disclosure are not limited thereto.

Each of the plurality of pixels PXL may include a light-emitting device and a driving element which generates an emission current based on a voltage difference between a gate and a source thereof to drive the light-emitting device.

The light-emitting device may include an anode electrode, a cathode electrode, and an organic compound layer formed between the electrodes. The organic compound layer may include a hole injection layer (HIL), a hole transport layer (HTL), an emission layer (EML), an electron transport layer (ETL), an electron injection layer (EIL), but is not limited thereto. When a pixel current flows through the light-emitting device, a hole passing through the hole transport layer (HTL) and an electron passing through the electron transport layer (ETL) may move to the emission layer (EML) to form an exciton, and thus, the emission layer (EML) may emit visible light. Alternatively, the organic compound layer may be replaced with an inorganic compound layer.

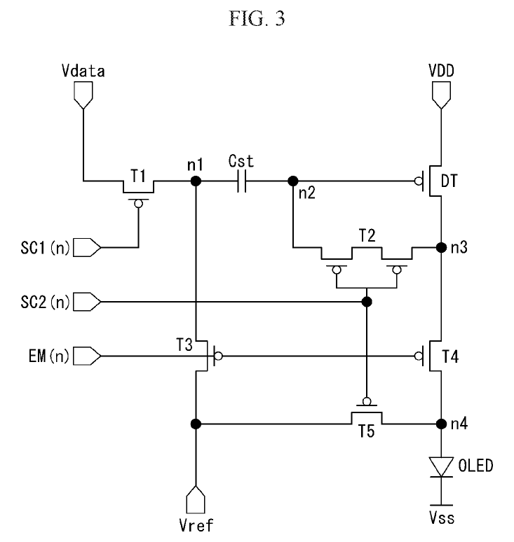

The driving element may be implemented with an organic substrate (or plastic substrate)-based low-temperature poly-silicon (LTPS) or an oxide thin film transistor (TFT), but is not limited thereto. The driving element may also be implemented as a silicon wafer (Si-wafer)-based complementary-metal-oxide-semiconductor (CMOS) transistor. Each pixel PXL may include a pixel driving circuit. This will be described below with reference to FIG. 3.

Meanwhile, the display panel 100 according to one or more embodiments of the present disclosure may be used as an automotive display panel 100, and considering vehicle instrument panels such as speedometers and fuel gauges, the display panel 100 may include a notch area NC where a portion thereof is recessed. Therefore, a portion of the active area AA may also include the notch area NC.

The notch area NC may have a width of a portion of a lower end of the active area AA in the first horizontal direction x and may be recessed upward in the second horizontal direction y.

Due to such a notch area NC, when the gate drivers 130 are distributed and disposed in the active area AA, an output characteristic of the scan signals SC1(n) and SC2(n) applied to side gate lines GL1, GL2, and GL3 disposed on a side surface of the notch area NC may differ from an output characteristic of the scan signals SC1(n) and SC2(n) applied to upper gate lines GL1, GL2, and GL3 disposed on the notch area NC.

Accordingly, a luminance difference may occur between light emitted by a light-emitting device of the subpixel PXL disposed on a side surface of the notch area NC and light emitted by a light-emitting device of the subpixel PXL disposed on the notch area NC. For example, in FIG. 1, a luminance difference may occur between a side subpixel PXL connected to the side gate lines GL1, GL2, and GL3 of the notch area NC and an upper subpixel PXL connected to the upper gate lines GL1, GL2, and GL3 of the notch area NC.

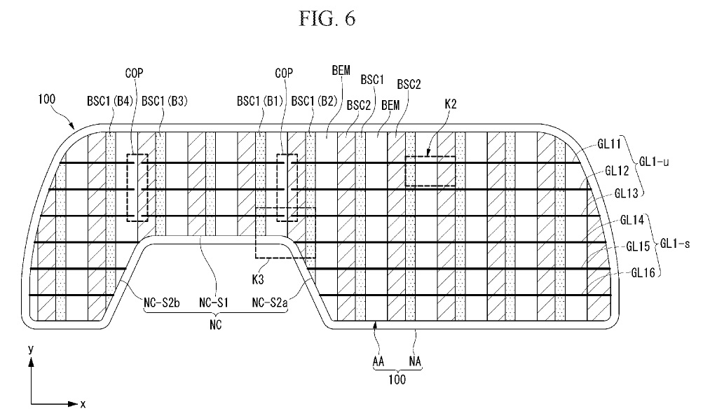

However, the present disclosure may include a plurality of open circuit portions where a portion of a first upper gate line, disposed on a notch area among the first gate lines GL1 receiving the first scan signal SC1(n) controlling the supply of the data voltage Vdata described above, is disconnected and opened , and thus, may improve a luminance deviation as described above, thereby more enhancing the quality of a display screen. This will be described below in detail with reference to FIG. 6.

FIG. 3 is an example of an equivalent circuit of a subpixel included in the pixel area of FIG. 2.

The subpixel PXL equivalent circuit illustrated in FIG. 3 may be an example, and the present disclosure is not limited thereto and may be replaced with another circuit configuration.

For example, as illustrated in FIG. 3, the subpixel PXL circuit may include a driving transistor DT, a plurality of switching transistors T1 to T5, a capacitor Cst, and a light-emitting device OLED.

The driving transistor DT may include a first electrode to which a high-level driving voltage VDD is applied, a second electrode connected to a third node n3, and a gate electrode connected to a second node n2. The driving transistor DT may generate a driving current based on data voltage Vdata applied to the second node n2 and may supply the data voltage Vdata to the third node n3.

The capacitor Cst may include a first electrode connected to a first node n1 and a second electrode connected to the second node n2, and the data voltage Vdata applied to the first node n1 may be stored therein.

The first transistor T1 may include a first electrode to which the data voltage Vdata is applied and a second electrode connected to the first node n1 and may receive the first scan signal SC1(n) applied to a gate electrode thereof. The first transistor T1 may transfer the data voltage Vdata to the first node n1 in response to the first scan signal SC1(n).

The second transistor T2 may include a first electrode connected to the third node n3, a second electrode connected to the second node n2, and a gate electrode receiving the second scan signal SC2(n). The second transistor T2 may be diode-connected between the gate electrode and the second electrode of the driving transistor DT.

The third transistor T3 may include a first electrode receiving a reference voltage Vref which is lower than the high-level driving voltage VDD, a second electrode connected to the first node n1, and a gate electrode receiving the emission control signal EM(n).

The fourth transistor T4 may include a first electrode connected to the third node n3, a second electrode connected to the fourth node n4, and a gate electrode receiving the emission control signal EM(n).

The fifth transistor T5 may include a first electrode to which the reference voltage Vref is applied, a second electrode connected to the fourth node n4, and a gate electrode receiving the second scan signal SC2(n).

The light-emitting device OLED may include an anode electrode connected to the fourth node n4 and a cathode electrode to which the low-level driving voltage VSS is applied.

The pixel circuit, for example, may operate as follows.

During the initialization period, the emission control signal EM(n) and the second scan signal SC2(n) having the turn-on voltage may be applied, and thus, the first to fourth nodes n1 to n4 may be initialized to the reference voltage Vref. During the programming period, the first scan signal SC1(n) having the turn-on voltage may be applied, and thus, the data voltage Vdata may be stored in the capacitor Cst, and the high-level driving voltage EVDD and a threshold voltage of the driving transistor DT may be supplied to the second node n2, and thus, the threshold voltage may be reflected in the data voltage Vdata and may be stored.

Subsequently, during the emission period, the emission control signal EM(n) having the turn-on voltage may be applied, and thus, the driving transistor DT may generate a driving current based on the data voltage Vdata, and the generated driving current may be supplied to the light-emitting device OLED. At this time, the generated driving current may have a compensated current value as the threshold voltage of the driving transistor DT is reflected therein.

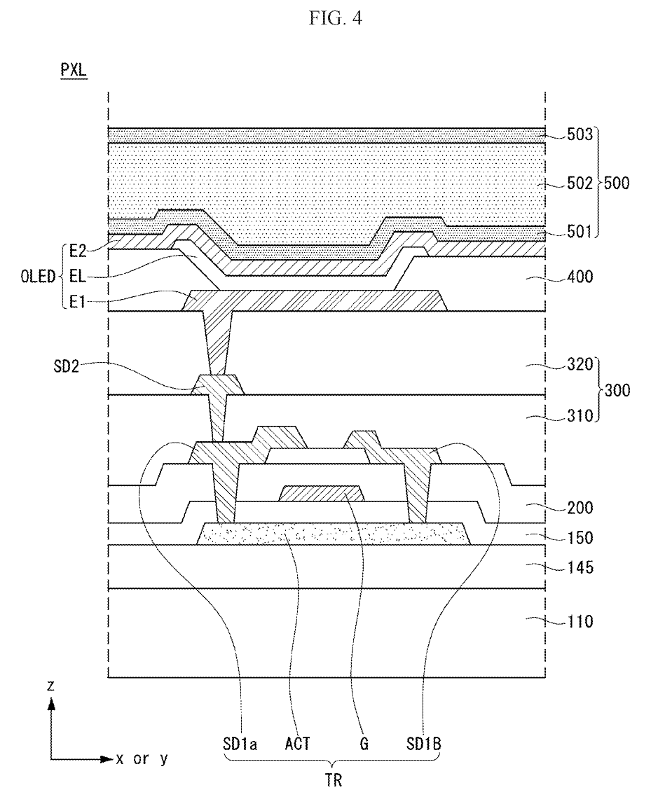

Such a subpixel PXL may have a cross-sectional structure as illustrated in FIG. 4.

FIG. 4 is an example of a cross-sectional view for describing a cross-sectional structure of a subpixel.

In FIG. 4, for convenience of understanding, only one transistor TR is illustrated, but is not limited thereto and a plurality of transistors TR illustrated in FIG. 3 may all be included in one pixel.

As illustrated in FIG. 4, a cross-sectional structure of the subpixel PXL may include a substrate 110, a buffer layer 145, a gate insulation layer 150, an interlayer insulation layer 200, a planarization layer 300, a bank 400, a light-emitting device OLED, a transistor TR, and an encapsulation layer 500.

Moreover, although not illustrated in FIG. 4, a lens, black matrix, and a touch electrode array may be additionally disposed on the encapsulation layer 500.

For example, the lens disposed on the encapsulation layer 500 may be provided as one in each pixel PXL, and a light-absorbing black matrix may be disposed between adjacent pixels PXL.

Furthermore, the lens and black matrix may also be disposed on the circuit area AG illustrated in FIG. 2. Therefore, at least some circuit areas AG among the plurality of circuit areas AG may be disposed with overlapping the lens and black matrix.

The touch electrode array may be disposed on the lens and the black matrix independently of the arrangement of the circuit area AC and the pixel area AP illustrated in FIG. 2.

The substrate 110 may be formed by using a plastic material having flexibility to have a flexible characteristic and may also include a glass material having a thin thickness and flexibility. The substrate 110 may be disposed in the active area AA and the non-active area NA of the display panel 100.

The buffer layer 145 may be disposed on the substrate 110 and may include an inorganic insulating material such as silicon oxide (SiO) and silicon nitride (SiN). The buffer layer 145 may include a multi-layer structure including the same material or different materials. A semiconductor layer ACT configuring the transistor TR may be disposed on the buffer layer 145.

The semiconductor layer ACT may include a channel region having low electrical conductivity and a carrier concentration, which is provided in a center of the semiconductor layer ACT overlapping a gate electrode G, and a source-drain region having high electrical conductivity and a carrier concentration may be provided at both sides of the channel region. The channel region may form a channel in response to a voltage applied to the gate electrode G, and a driving current may flow through the formed channel.

The semiconductor layer ACT may include, for example, a semiconductor material such as low-temperature polycrystalline silicon (LTPS), or may include an oxide semiconductor material such as indium-gallium-zinc oxide (IGZO).

The gate insulation layer 150 may cover the buffer layer 145 and be disposed on the semiconductor layer ACT. The gate insulation layer 150 may include an inorganic insulating material such as silicon oxide (SiOx), silicon nitride (SiNx), or silicon oxynitride (SiOxNy). The gate electrode G configuring the transistor TR may be disposed on the gate insulation layer 150. The gate electrode G may overlap the semiconductor layer ACT. The gate electrode G may be supplied with the first and second scan signals SC1(n) and SC2(n) or the emission control signal EM(n), or a voltage of the second node n2 may be applied thereto. The gate insulation layer 150 may insulate the semiconductor layer ACT from the gate electrode G.

The interlayer insulation layer 200 may cover the gate electrode G and may be disposed on the gate insulation layer 150. The interlayer insulation layer 200 may include an inorganic insulating material such as SiOx, SiNx, or SiOxNy. A source electrode SD1a and a drain electrode SD1b each configuring the transistor TR may be disposed on the interlayer insulation layer 200. The interlayer insulation layer 200 may insulate the source electrode SD1a and the drain electrode SD1b from the gate electrode G.

Each of the source electrode SD1a and the drain electrode SD1b may pass through the interlayer insulation layer 200 and the gate insulation layer 150 and may be electrically connected to a source-drain region of the semiconductor layer ACT.

The source electrode SD1a and the drain electrode SD1b may include the same material, and for example, may include at least one of metals such as aluminum (Al), chromium (Cr), copper (Cu), titanium (Ti), molybdenum (Mo), and tungsten (W).

The planarization layer 300 may cover the source electrode SD1a and the drain electrode SD1b and may be disposed on the interlayer insulation layer 200. The planarization layer 300 may remove a step height caused by the transistor TR and may include a flat surface. The planarization layer 300 may include an organic insulating material having high fluidity.

The planarization layer 300 may include a first planarization layer 310 and a second planarization layer 320 disposed on the first planarization layer 310. A middle electrode SD2 may be disposed between the first and second planarization layers 310 and 320, and the middle electrode SD2 may electrically connect one of the source electrode SD1a and the drain electrode SD1b to an anode electrode E1 of the light-emitting device OLED.

The middle electrode SD2 may pass through the first planarization layer 310, may be electrically connected to one electrode, and may be electrically connected to the anode electrode E1 passing through the second planarization layer 320. The middle electrode SD2 may include at least one metal among metals such as Al, Cr, Cu, Ti, Mo, and W.

The anode electrode E1 configuring the light-emitting device OLED may be disposed on the second planarization layer 320.

As described above, the transistor TR may include the semiconductor layer ACT, the gate electrode G, the source electrode SD1a, and the drain electrode SD1b.

The bank 400 may cover an edge of the anode electrode E1 and may be disposed on the second planarization layer 320. The bank 400 may define an emission area of each pixel PXL. That is, the emission area of each pixel PXL may be divided by the bank 400.

The light-emitting device OLED may include the anode electrode E1, an emission layer EL, and a cathode electrode E2. The emission layer EL and the cathode electrode E2 may be disposed in a partial region of the anode electrode E1 exposed by the bank 400.

The emission layer EL may emit light, and a luminance of the light may be controlled by a voltage difference formed between the anode electrode E1 and the cathode electrode E2. The emission layer EL may include an emission material layer including an organic material.

The encapsulation layer 500 may be disposed on the light-emitting device OLED and the bank 400 of each pixel PXL. The encapsulation layer 500 may prevent damage of the light-emitting devices OLED caused by an external impact and water. The encapsulation layer 500 may have a multi-layer structure. For example, the encapsulation layer 500 may be formed by alternately stacking first and second inorganic insulation layers 501 and 503 including an inorganic insulating material and an organic insulation layer 502 including an organic insulating material. For example, the organic insulation layer 502 may be provided between the first and second inorganic insulation layers 501 and 503.

The first inorganic insulation layer 501 may be disposed in the active area AA and the non-active area NA. The first inorganic insulation layer 501 may be disposed on the bank 400 while covering the cathode electrode E2.

The organic insulation layer 502 may be disposed on the first inorganic insulation layer 501 in the active area AA and the non-active area NA. The organic insulation layer 502 may remove a step height caused by the plurality of light-emitting devices OLED.

The second inorganic insulation layer 503 may be disposed on the organic insulation layer 502 in the active area AA and the non-active area NA, thereby sealing the organic insulation layer 502.

Accordingly, the encapsulation layer 500 may effectively prevent damage of the light-emitting device OLED caused by an external impact and water. A step height caused by the light-emitting device OLED of each pixel may be removed by the encapsulation layer 500. For example, a top surface of the encapsulation layer 500 facing the substrate 110 may be a flat plane.

The subpixel PXL described above may be provided in each pixel area AP of the active area AA.

Meanwhile, the shift register included in the gate driver 130 described above may include first and second scan circuits and an EM circuit, as described above. This will be described below.

FIG. 5 is a diagram for describing a configuration of a shift register included in the gate driver of FIG. 2.

A shift register included in the gate driver 130 may include a plurality of stages STG1 to STGm. The plurality of stages STG1 to STGm may have a dependent connection relationship to sequentially output signals. The plurality of stages STG1 to STGm may include first scan circuits SCN1 generating the first scan signal SC1(n), second scan circuits SCN2 generating the second scan signal SC2(n), and EM circuits EMD generating the emission control signal EM(n).

Each of the first and second scan circuits SCN1 and SCN2 and the EM circuits EMD may be connected to a line to which each of clock signals GCLKS and ECLKS is applied and a line to which the turn-on voltage (for example, VGL and EVL) and the turn-off voltage (for example, VGH and EVH) are applied.

The first and second scan circuits SCN1 and SCN2 and the EM circuits EMD disposed in each stage may be connected dependently, and signals generated in a front end may be input as a start signal of a rear end.

The first and second scan circuits SCN1-1 and SCN2-1 and the EM circuit EMD-1 disposed in the first stage STG1 may receive start signals GVST and EVST, and thus, an operation of each of the first and second scan circuits SCN1 and SCN2 and the EM circuits EMD may start.

Each of first and second scan circuits SCN1-2 to SCN1-m and SCN2-2 to SCN2-m) and EM circuits EMD-2 to EMD-m respectively disposed in rear-end stages STG2 to STGm may use, as a start signal, an output signal of a circuit disposed in a front-end stage.

As described above, the first and second scan circuits SCN1 and SCN2 and the EM circuits EMD disposed in each stage may be distributed and disposed in the plurality of circuit areas AG. This may be described below with reference to FIG. 6.

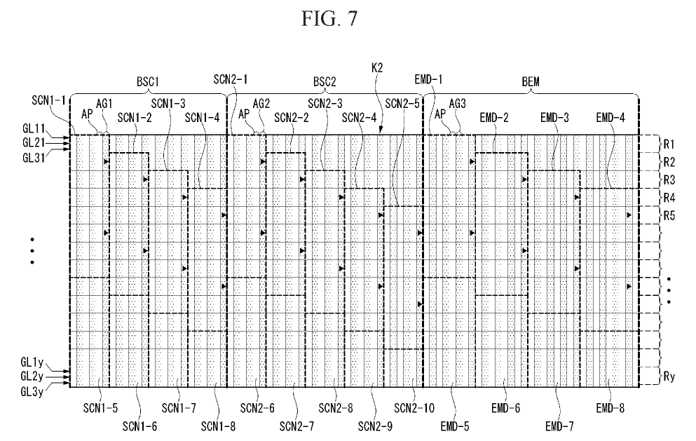

FIG. 6 schematically illustrates an arrangement structure of first, second, and third scan blocks included in a display panel, and FIG. 7 is an enlarged view of a K2 portion in FIG. 6.

In FIG. 6, for convenience of understanding, the second and third gate lines GL2 and GL3 are omitted in the active area AA, and only the first gate line GL1 is briefly illustrated, but embodiments of the present disclosure are not limited thereto and the second and third gate lines GL2 and GL3 may be provided.

Hereinafter, for convenience of description, in the plurality of first, second, and third gate lines GL1, GL2, and GL3, a gate line disposed on a side surface of the notch area NC and disposed on a side surface of the notch area NC in the first direction x in an extension line of a line may be referred to as a side gate line, and a gate line which is disposed on an upper portion of the notch area NC in the second direction y and where the notch area NC is not disposed in an extension line of a line may be referred to as an upper gate line.

That is, the side gate line may be disposed on a side surface of the notch area NC, and an end of the side gate line may contact a side surface (or an inclined surface) of the notch area NC, and the upper gate line may be disposed on the notch area NC, and an end of the upper gate line may not contact the side surface of the notch area NC.

Therefore, each of the plurality of first, second, and third gate lines GL1, GL2, and GL3 described above may include first, second, and third side gate lines and first, second, and third upper gate lines.

In FIG. 6, in the plurality of first gate lines GL1, first-1 to third-3 gate lines GL11 to GL13 may be a first upper gate line GL1-u, and first-4 to first-6 gate lines GL14 to GL16 may be the first side gate line GL1-s.

As in FIG. 6, when the first side gate line GL1-s is disposed on both sides with respect to the notch area NC, the first side gate line GL1-s disposed on one side of the notch area NC may be electrically isolated from the first side gate line GL1-s disposed on the other side of the notch area NC.

Hereinafter, in the plurality of circuit areas AG, a plurality of circuit areas AG where the first scan circuit SCN1 is disposed may be referred to as a plurality of first circuit areas AG1, a plurality of circuit areas AG where the second scan circuit SCN2 is disposed may be referred to as a plurality of second circuit areas AG2, and a plurality of circuit areas AG where the EM circuit EMD is disposed may be referred to as a plurality of third circuit areas AG3.

Furthermore, in FIG. 7, for convenience of understanding, a plurality of first, second, and third gate lines GL11 to GL1y, GL21 to GL2y, and GL31 to GL3y are illustrated on a side surface of a K2 portion, but each of the first, second, and third gate lines GL11 to GL1y, GL21 to GL2y, and GL31 to GL3y may extend in the first direction x and may overlap a plurality of pixel areas AP and a plurality of first, second, and third circuit areas AG1, AG2, and AG3. Each of the plurality of first, second, and third gate lines GL11 to GL1y, GL21 to GL2y, and GL31 to GL3y may be electrically connected to a plurality of subpixels PXL arranged in the plurality of pixel areas AP.

As described above, the first and second scan circuits SCN1-1 to SCN1-8, and SCN2-1 to SCN2-10 and the EM circuits EMD-1 to EMD-8 may be distributed and disposed in the plurality of circuit areas AG.

For example, the first scan circuits SCN1-1 to SCN1-8 may be distributed and disposed in first scan blocks BSC1 including the plurality of first circuit areas AG1, the second scan circuits SCN2-1 to SCN2-10 may be distributed and disposed in second scan blocks BSC2 including the plurality of second circuit areas AG2 except the first circuit area AG1, and the EM circuits EMD-1 to EMD-8 may be distributed and disposed in EM blocks BEM including the plurality of third circuit areas AG3 except the first and second circuit areas AG1 and AG2.

In FIG. 6, the first scan blocks BSC1, the second scan blocks BSC2, and the EM blocks BEM may be provided in an entire area of the active area AA. In each of the first and second scan blocks BSC1 and BSC2 and the EM blocks BEM, the plurality of pixel areas AP may be alternately arranged between the plurality of first, second, and third circuit areas AG1, AG2, and AG3.

For example, as illustrated in FIG. 7, the plurality of first circuit areas AG1 and the plurality of pixel areas AP may be alternately arranged in the first direction x in the first scan block BSC1, the plurality of second circuit areas AG2 and the plurality of pixel areas AP may be alternately arranged in the first direction x in the second scan block BSC2, and the plurality of third circuit areas AG3 and the plurality of pixel areas AP may be alternately arranged in the first direction x in the EM block BEM.

The plurality of first scan circuits SCN1-1 to SCN1-m illustrated in FIG. 5 may be disposed for each of the plurality of first scan blocks BSC1 of FIG. 6, the plurality of second scan circuits SCN2-1 to SCN2-m may be disposed for each of the plurality of second scan blocks BSC2, and the plurality of EM circuits EMD-1 to EMD-m may be disposed for each of the plurality of EM blocks BEM.

That is, all of the plurality of first scan circuits SCN1-1 to SCN1-m illustrated in FIG. 5 may be disposed in one first scan block BSC1 illustrated in FIG. 7.

For example, as illustrated in FIG. 7, the first-1 to first-4 scan circuits SCN1-1 to SCN1-4 may be arranged in the first direction x in the first scan block BSC1. The first-5 to first-8 scan circuits SCN1-5 to SCN1-8 may be arranged in the first direction x in the first scan block BSC1, but are not limited thereto and may be disposed under the first-1 to first-4 scan circuits SCN1-1 to SCN1-4 in the second direction y. In this manner, the first-1 to first-m scan circuits SCN1-1 to SCN1-m of FIG. 5 may be disposed in each first scan block BSC1.

The first-1 scan circuit SCN1-1 may be electrically connected to a first-1 gate line GL11 of a first row R1, and the first-1 gate line GL11 may be electrically connected to a plurality of subpixels PXL disposed in a pixel area AP of the first row R1.

The first-1 scan signal SC1(1) generated by the first-1 scan circuit SCN1-1 may be supplied to the plurality of subpixels PXL disposed in the pixel area AP of the first row R1.

The first-2 scan circuit SCN1-2 may be electrically connected to a first-2 gate line GL12 of a second row R2, and the first-2 gate line GL12 may be electrically connected to a plurality of subpixels PXL disposed in a pixel area AP of the second row R2.

The first-2 scan signal SC1(2) generated by the first-2 scan circuit SCN1-2 may be supplied to the plurality of subpixels PXL disposed in the pixel area AP of the first row R1. The first-1 scan signal SC1(1) generated by the first-1 scan circuit SCN1-1 may be input to the first-2 scan circuit SCN1-2 as a start signal. Furthermore, the first-2 gate line GL12 may overlap the first-1 scan circuit SCN1-1 but may not be electrically connected to each other.

In this manner, the first-1 to first-m scan circuits SCN1-1 to SCN1-m in FIG. 5 may be disposed in each first scan block BSC1.

All of the plurality of second scan circuits SCN2-1 to SCN2-10 illustrated in FIG. 5 may be disposed in one second scan block BSC2 illustrated in FIG. 7.

For example, as in FIG. 7, second-1 to second-5 scan circuits SCN2-1 to SCN2-5 may be arranged in the second scan block BSC2 in the first direction x. Second-6 to second-10 scan circuits SCN2-6 to SCN2-10 may be arranged in the second scan block BSC2 in the first direction x, but are not limited thereto and may be disposed under the second-1 to second-5 scan circuits SCN2-1 to SCN2-5 in the second direction y. In this manner, the second-1 to second-m scan circuits SCN2-1 to SCN2-m of FIG. 5 may be disposed in each second scan block BSC2.

Likewise the first scan circuit SCN1, the second-1 to second-m scan circuits SCN2-1 to SCN2-m illustrated in FIG. 5 may be electrically connected to the second gate line GL2 of each of the first row R1 to an mth row (not shown) and may be electrically connected to the subpixels PXL arranged in the pixel area AP of each row to supply the second scan signal SC2(n). In this manner, the second-1 to second-m scan circuits SCN2-1 to SCN2-m of FIG. 5 may be disposed in each second scan block BSC2.

All of the plurality of EM circuits EMD-1 to EMD-m illustrated in FIG. 5 may be disposed in one EM block BEM illustrated in FIG. 7.

For example, as illustrated in FIG. 7, first-1 to first-4 EM circuits EMD-1 to EMD-4 may be arranged in the first direction x in the EM block BEM. First-5 to first-8 EM circuits EMD-5 to EMD-8 may be arranged in the EM block BEM in the first direction x, but are not limited thereto and may be disposed under the first-1 to first-4 EM circuits EMD-1 to EMD-4 in the second direction y. In this manner, the first-1 to first-m EM circuits EMD-1 to EMD-m of FIG. 5 may be disposed in each EM block BEM.

Likewise the first and second scan circuits, the first-1 to first-m EM circuits EMD-1 to EMD illustrated in FIG. 5 may be electrically connected to third gate lines GL3 of the first row R1 to the mth row (not shown) and may be electrically connected to a plurality of subpixels PXL disposed in the pixel area AP of each row to supply the emission control signal EM(n). In this manner, the first-1 to first-m EM circuits EMD-1 to EMD in FIG. 5 may be disposed within each EM block BEM.

As described above, the first and second scan circuits SCN1 and SCN2 and the EM circuits EMD-1 to EMD-8 may be respectively distributed and disposed in the first and second scan blocks BSC1, BSC2 and the EM blocks BEM arranged in the active area AA.

Each first scan block BSC1 may output a plurality of first scan signals SC1(n) to both sides in the first direction x with respect to each first scan block BSC1. Each second scan block BSC2 may output a plurality of second scan signals SC2(n) to both sides in the first direction x with respect to each second scan block BSC2. Each EM block BEM may output a plurality of emission control signals EM(n) to both sides in the first direction x with respect to each EM block BEM.

The notch area NC provided in the display panel 100 may include a top surface NC-S1 extending in the first direction x and inclined surfaces NC-S2a and NC-S2b which are inclined in a direction intersecting with the first and second directions at an end of the top surface NC-S1.

When the notch area NC is provided as illustrated in FIG. 6, a plurality of first upper gate lines GL1-u arranged on the notch area NC may include a plurality of open circuit portions COP where a portion is disconnected and opened. An open-circuited end of the first upper gate line GL1-u may be spaced apart from the open circuit portion COP in the first direction x.

The plurality of open circuit portions COP included in the plurality of first upper gate lines GL1-u, as illustrated in FIG. 6, may be disposed adjacent to a portion where the top surface NC-S1 of the notch area NC and the inclined surfaces NC-S2a and NC-S2b of the notch area NC.

In detail, as illustrated in FIG. 6, the first scan blocks BSC1 distributed and disposed in the active areas AA may include first blocks B1 and B3 and second blocks B2 and B4.

The first blocks B1 and B3 and the second blocks B2 and B4 may be spaced apart from each other in the first direction x and may each extend in the second direction y. The top surface NC-S1 may be disposed in a portion where the first blocks B1 and B3 extend, and the inclined surfaces NC-S2a and NC-S2b may be disposed in a portion where the second blocks B2 and B4 extend.

A plurality of open circuit portions COP may be arranged between the first blocks B1 and B3 and the second blocks B2 and B4 as in FIG. 6.

In embodiments of the present disclosure, the plurality of open circuit portions COP may be provided adjacent to a portion where the top surface NC-S1 of the notch area NC contacts the inclined surfaces NC-S2a and NC-S2b, and thus, a luminance difference between a side region and an upper region of the notch area NC, thereby improving image quality.

In FIG. 6, a case where the plurality of open circuit portions COP are disposed between the first blocks B1 and B3 disposed on the top surface NC-S1 and the second blocks B2 and B4 disposed on the inclined surfaces NC-S2a and NC-S2b is illustrated as an example, but embodiments of the present disclosure are not limited thereto.

For example, when the first scan block BSC1 is not disposed on and is disposed outside the inclined surfaces NC-S2a and NC-S2b, the plurality of open circuit portions COP may be disposed between the first scan block BSC1 disposed on the top surface NC-S1 and the first scan block BSC1 disposed outside the inclined surfaces NC-S2a and NC-S2b with the inclined surfaces NC-S2a and NC-S2b therebetween.

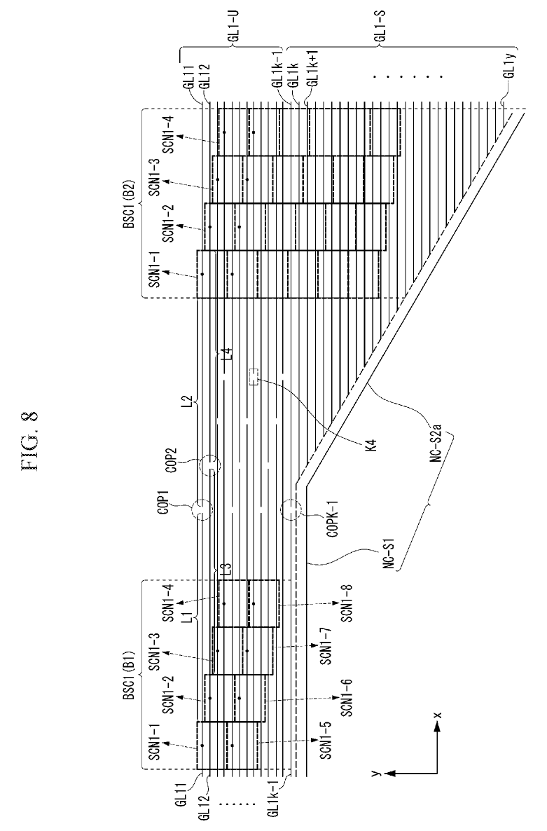

FIG. 8 is an enlarged view of a K3 portion in FIG. 6 so as to describe in more detail an open circuit portion included in each of a first gate line and first and second blocks of a first scan block.

In FIG. 8, for convenience of understanding, first and second blocks B1 and B2, a plurality of first gate lines GL11-1y, and a plurality of open circuit portions COP1 to COPk-1 are illustrated, and the illustrations of the second scan block BSC2, the second gate line GL2, the EM block BEM, the third gate line GL3, the plurality of pixel areas AP, and the plurality of circuit areas AG are omitted.

As illustrated in FIG. 8, a plurality of first scan circuits SCN1 may be disposed in the first block B1 of the first scan block BSC1, and a plurality of first scan circuits SCN1 may be disposed in the second block B2 of the first scan block BSC1. The number of first scan circuits SCN1 disposed in the first block B1 and the number of first scan circuits SCN1 disposed in the second block B2 may differ due to a length difference therebetween in the second direction y.

The plurality of first scan circuits SCN1 disposed in the first block B1 may be connected to a plurality of first upper gate lines GL1-u and GL11 to GL1k-1 to supply the first scan signal SC1(n).

Some of the plurality of first scan circuits SCN1 disposed in the second block B2 may be connected to the plurality of first upper gate lines GL1-u and GL11 to GL1k-1 to supply the first scan signal SC1(n). The plurality of first scan circuits SCN1 disposed on a side surface of the notch area NC may be connected to a plurality of first side gate lines GL1-s and GL1k to GL1y to supply the first scan signal SC1(n).

In detail, each of the first and second blocks B1 and B2 may include a first-1 scan circuit SCN1-1 and a first-2 scan circuit SCN1-2. In each of the first and second blocks B1 and B2, the first-1 scan circuit SCN1-1 and the first-2 scan circuit SCN1-2 may be adjacent to each other in the first direction x.

The first-1 scan circuit SCN1-1 may be connected to the first line GL11 of the first upper gate line GL1-u and may supply the first scan signal SC1(n), and the first-2 scan circuit SCN1-2 may be connected to the second line GL12 of the first upper gate line GL1-u and may supply the first scan signal SC1(n).

A first open circuit portion COP1 may be disposed on the first line GL11 of the first upper gate line GL1-u, between the first-1 scan circuit SCN1-1 of the first block B1 and the first-1 scan circuit SCN1-1 of the second block B2, and a second open circuit portion COP2 may be disposed on the second line GL12 of the first upper gate line GL1-u, between the first-2 scan circuit SCN1-2 of the first block B1 and the first-2 scan circuit SCN1-2 of the second block B2.

A first length L1 up to the first open circuit portion COP1 from the first-1 scan circuit SCN1-1 of the first block B1 may be equal to a second length L2 up to the first open circuit portion COP1 from the first-1 scan circuit SCN1-1 of the second block B2.

For example, in the first line GL11, the number of subpixels PXL or pixel areas AP disposed between the first open circuit portion COP1 and the first-1 scan circuit SCN1-1 of the first block B1 may be the same as the number of subpixels PXL or pixel areas AP disposed between the first open circuit portion COP1 and the first-1 scan circuit SCN1-1 of the second block B2.

Furthermore, a third length L3 up to the second open circuit portion COP2 of the first block B1 from the first-2 scan circuit SCN1-2 of the first block B1 may be equal to a fourth length L4 up to the second open circuit portion COP2 from the first-2 scan circuit SCN1-2 of the second block B2.

For example, in the second line GL12, the number of subpixels PXL or pixel areas AP disposed between the first-second scan circuit SCN1-2 and the second open circuit portion COP2 of the first block B1 may be the same as the number of subpixels PXL or pixel areas AP disposed between the first-2 scan circuit SCN1-2 of the second block B2 and the second open circuit portion COP2.

The first open circuit portion COP1 and the second open circuit portion COP2 may not be disposed in the same line in the second direction y and may be disposed spaced apart from each other in the first direction x, and moreover, may be disposed to be staggered with each other. That is, when the first open circuit portion COP1 and the second open circuit portion COP2 are disposed in the circuit area AG, the first open circuit portion COP1 and the second open circuit portion COP2 may be disposed in different circuit areas AG.

As described above, in the present disclosure, the first length L1 and the second length L2 may be equal to each other, and the third length L3 and the fourth length L4 may be equal to each other, and thus, output characteristics of the first scan signals SC1(n) output in directions toward the first and second open circuit portions COP1 and COP2 from the first and second blocks B1 and B2 may be equal to each other, thereby improving image quality.

Hereinafter, an example where the first and second scan circuits and the EM circuit EMD are disposed in the active area AA will be described.

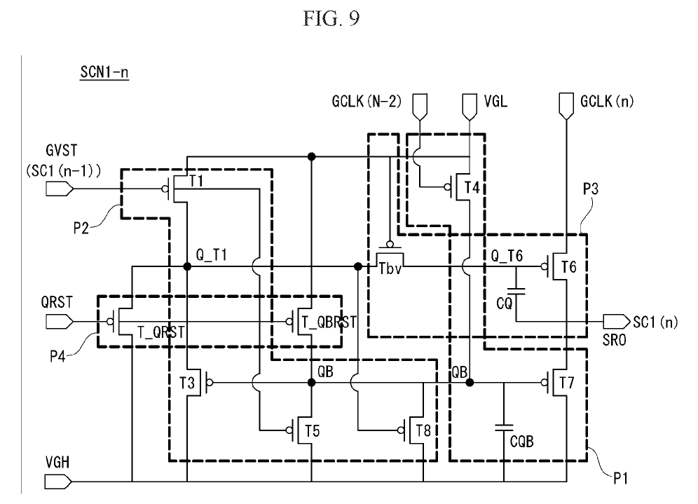

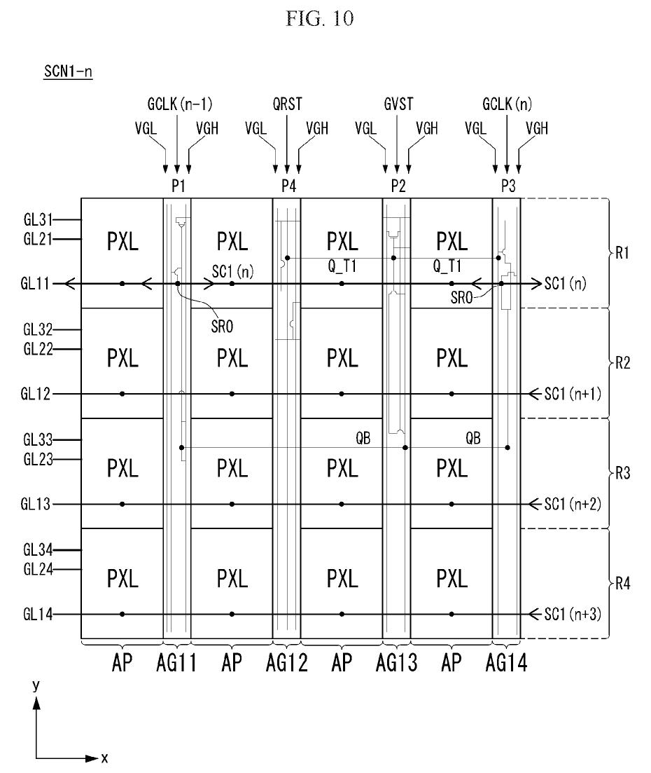

FIG. 9 is a diagram for describing a configuration of each of first and second scan circuits, and FIG. 10 is a diagram for describing an example where the first and second scan circuits of FIG. 9 are applied to a plurality of first and second circuit areas.

A first scan circuit SCN1 illustrated in FIG. 9 may be an example, a configuration of the first scan circuit SCN1 according to one or more embodiments of the present disclosure is not limited to FIG. 9, and the first scan circuit SCN1 may be variously configured.

A first-n scan circuit SCN1-n of FIG. 9 may be a first scan circuit SCN1 of an nth stage. Therefore, the first-n scan circuit SCN1-n illustrated in FIG. 9 may be applied to a first scan circuit SCN1 of each stage described with respect to FIGS. 5-8.

A gate high voltage VGH, a gate low voltage VGL, a current clock signal GCLK(n), a previous clock signal GCLK(n-2), a gate start signal GVST or a first scan signal SC1(n-1) of a front end, and a reset signal QRST may be applied to the first-n scan circuit SCN1-n, and the first-n scan circuit SCN1-n may include a scan output terminal SRO. The scan output terminal SRO may be connected to an nth line of the first gate line GL1 to output a first scan signal SC1(n). For example, when the first-n scan circuit SCN1-n is the first-2 scan circuit SCN1-2 of FIGS. 5-8, the scan output terminal SRO may be connected to a first-3 scan circuit SCN1-3, and the first scan signal SC1(n) may be supplied as a gate start signal GVST of the first-3 scan circuit SCN1-3.

As illustrated in FIG. 9, the first-n scan circuit SCN1-n may include a plurality of transistors and a plurality of capacitors connected with respect to Q nodes Q_T1 and Q_T6 and a QB node QB.

The plurality of transistors may include T1 and T3 to T8 transistors, a Tbv transistor, a T_QRST transistor, a T_QBRST transistor, a CQ capacitor, and a CQB capacitor.

The first-n scan circuit SCN1-n may include first to fourth portions P1 to P4.

The first portion P1 may include the T4 and T7 transistors and a CQB capacitor. The previous clock signal GCLK(n-2), the gate high voltage VGH, and the gate low voltage VGL may be supplied to the first portion P1. The first portion P1 may be connected to the scan output terminal SRO.

The second portion P2 may include the T1, T3, T5, and T8 transistors. The second portion P2 may be supplied with the gate start signal GVST or the first scan signal SC1(n-1) of a previous stage, the gate low voltage VGL, and the gate high voltage VGH.

The third portion P3 may include the T6 and Tbv transistors and the CQ capacitor. The third portion P3 may be supplied with the current clock signal GCLK(n) and the gate low voltage VGL. The third portion P3 may be connected to the scan output terminal SRO.

The fourth portion P4 may include the T_QRST transistor and the T_QBRST transistor, and the fourth portion P4 may be supplied with the reset signal and the gate high voltage VGH.

Such a first-n scan circuit SCN1-n may generate a first scan signal SC1(n) through the first to fourth portions P1 to P4 and may supply the first scan signal SC1(n) to the nth line of the first gate line GL1.

The first to fourth portions P1 to P4 of the first to nth scan circuit (SCN1-n), for example, may be distributed and disposed in a plurality of first circuit areas AG11 to AG14 as illustrated in FIG. 10.

In FIG. 10, it is illustrated that a plurality of first gate lines GL11-1y extend in the first direction x and overlap the plurality of pixel areas AP and a plurality of first circuit areas (AG11 to AG14) and a plurality of second and third gate lines GL21 to GL24 and GL31 to GL34, but this may be for convenience of understanding and the plurality of second and third gate lines GL21 to GL24 and GL31 to GL34 may also extend in the first direction x in each of the rows R1 to R4 and may overlap the plurality of pixel areas AP and the plurality of first circuit areas AG11 to AG14. Also, in FIG. 10, the nth line of the first gate line GL1 is referred to by GL11.

For example, in the first-n scan circuit SCN1-n illustrated in FIG. 9, the first portion P1 may be disposed in the first-1 circuit area AG11 of FIG. 10, the second portion P2 may be disposed in the first-3 circuit area AG13, the third portion P3 may be disposed in the first-4 circuit area AG4, and the fourth portion P4 may be disposed in the first-2 circuit area AG2.

The previous clock signal GCLK(n-2), the gate high voltage VGH, and the gate low voltage VGL, which are to be supplied to the first portion P1, may be supplied to a plurality of lines extending in the second direction y in the first-1 circuit area AG11.

The reset signal QRST and the gate high voltage VGH, which are to be supplied to the fourth portion P4, may be supplied to a plurality of lines extending in the second direction y in the first-2 circuit area AG12. Also, depending on the case, the gate low voltage VGL may be further supplied to the lines extending in the second direction y.

The gate start signal GVST or the first scan signal SC1(n-1) of the previous stage, the gate low voltage VGL, and the gate high voltage VGH, which are to be supplied to the second portion P2, may be supplied to a plurality of line extending in the second direction y in the first-3 circuit area AG13.

The current clock signal GCLK(n) and the gate low voltage VGL, which are to be supplied to the fourth portion P4, may be supplied to a plurality of lines extending in the second direction y in the first-4 circuit area AG14. Also, depending on the case, the high-level driving voltage VDD supplied to the subpixels PXL of the pixel area AP may be further supplied to the lines extending in the second direction y.

The scan output terminals SRO of the first-n scan circuit SCN1-n may be connected to the first portion P1 and the third portion P3 in common and may be connected to the nth line GL11 of the first gate line GL1, and thus, at a point at which each of the first-1 circuit area AG11 and the first-4 circuit area AG14 intersects with the line GL11 of the first row R1, the scan output terminal SRO of the first-n scan circuit SCN1-n may be connected thereto.

Furthermore, the plurality of subpixels PXL arranged in the pixel area AP of the first row R1 may be connected to an nth first gate line GL11 and may be supplied with the first scan signal SC1(n) of the first-n scan circuit SCN1-n through the nth first gate line GL11. Also, in the first-n scan circuit SCN1-n of FIG. 9, for example, the Q_T1 node connected to the second portion P2, the third portion P3, and the fourth portion P4 in common may be implemented as a Q_T1 line which overlaps the subpixel PXL disposed in the pixel area AP and extends in the first direction x. As illustrated in FIG. 10, the Q_T1 line may contact the first-2 circuit area AG12, the first-3 circuit area AG13, and the first-4 circuit area AG14.

Moreover, in the first-n scan circuit SCN1-n of FIG. 9, for example, the QB node connected to the first portion P1, the second portion P2, and the fourth portion P4 in common may be implemented as a QB line which overlaps the subpixel PXL disposed in the pixel area AP and extends in the first direction x. As illustrated in FIG. 10, the QB line may contact the first-1 circuit area AG11, the first-3 circuit area AG13, and the first-4 circuit area AG14.

As described above, the first-n scan circuit SCN1-n according to one or more embodiments of the present disclosure, which includes a plurality of driving elements such as a plurality of transistors and a capacitor, may be distributed and disposed in the plurality of first circuit areas AG11 to AG14, and lines such as the Q_T1 line and the QB line connecting the plurality of driving elements with each other may extend in the first direction x and may overlap the subpixel PXL.

Furthermore, although not illustrated in FIG. 10, a plurality of second and third gate lines GL21 to GL24 and GL31 to GL34 may extend in the first direction x and may overlap the plurality of first circuit areas AG11 to AG14, but the plurality of second and third gate lines GL21 to GL24 and GL31 to GL34 may not be connected to the plurality of first circuit areas AG11 to AG14. However, the plurality of second and third gate lines GL21 to GL24 and GL31 to GL34 may be connected to a plurality of subpixels PXL arranged between the plurality of first circuit areas AG11 to AG14.

Moreover, as illustrated in FIG. 10, lines GL12 to GL14 of the first gate line GL1 may extend and overlap the first-n scan circuit SCN1-n, but are not limited thereto and may not be connected to the first-n scan circuit SCN1-n and may be connected to a plurality of subpixels PXL arranged in the pixel area AP of the second to fourth rows R2 to R4.

First scan signals SC1(n+1) to SC1(n+3) generated from the other first scan circuit SCN1 except the first-n scan circuit SCN1-n in the first scan block BSC1 may be supplied to the lines GL12 to GL14 of the first gate line GL1.

The second scan circuit SCN2 may be distributed and disposed in a plurality of second circuit areas AG2 and may generate a second scan signal SC2(n) to supply the second scan signal SC2(n) to the second gate line GL2.

A method where the second scan circuits SCN2 included in the second scan block BSC2 are distributed and disposed in the plurality of second circuit areas AG2 may be the same as a method where the first scan circuit SCN1 is disposed in each of the plurality of first circuit areas AG11 to AG14. Therefore, a description thereof is omitted.

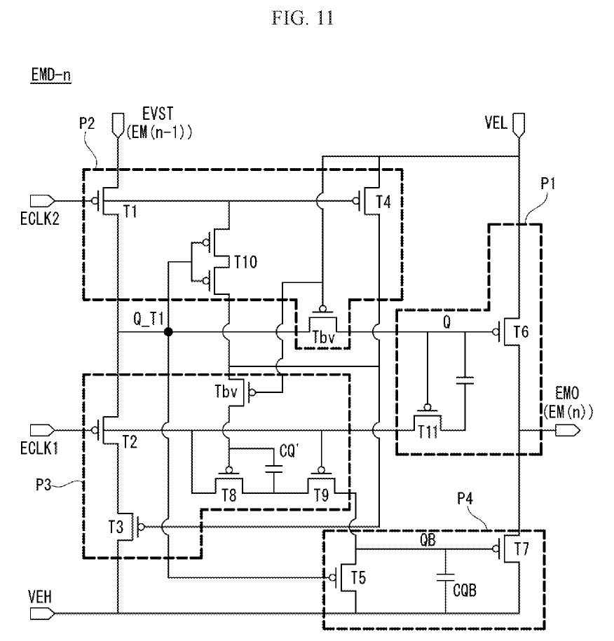

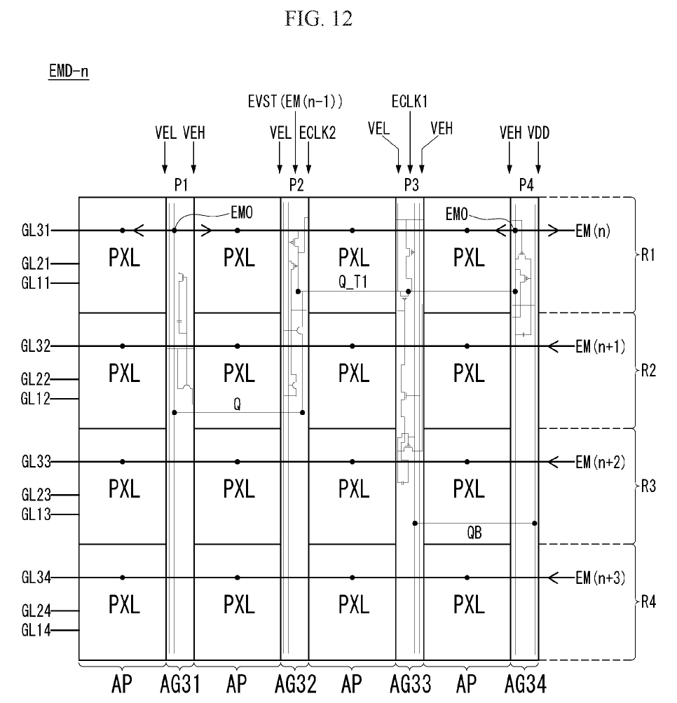

FIG. 11 is a diagram for describing an example of an EM circuit illustrated in FIG. 7, and FIG. 12 is a diagram for describing an example where the EM circuit of FIG. 11 is applied to a plurality of third circuit areas.

An EM circuit EMD illustrated in FIG. 11 may be an example, a configuration of the EM circuit EMD is not limited to FIG. 11, and the EM circuit EMD may be variously configured.

The nth EM circuit EMD-n in FIG. 11 may be an EM circuit EMD of an nth stage. Therefore, an nth EM circuit EMD-n illustrated in FIG. 11 may be applied to the EM circuit EMD of each stage described with reference to FIGS. 5-8. Accordingly, the nth EM circuit EMD-n may generate an emission control signal EM(n) and supply the emission control signal EM(n) to an nth line GL31 of a third gate line GL3.

An EM start signal EVST or an emission control signal EM(n-1) of a front end, a gate high voltage VEH, a gate low voltage VEL, and a plurality of EM clock signals ECLK1 and ECLK2 may be supplied to the nth EM circuit EMD-n, and the nth EM circuit EMD-n may include an EM output terminal EMO. When the nth EM circuit EMD-n is the second EM circuit EMD illustrated in FIGS. 5-8, the EM output terminal EMO may be connected to a third EM circuit EMD, and the emission control signal EM(n) output from the EM output terminal EMO may be supplied as an EM start signal EVST of the third EM circuit EMD.

As illustrated in FIG. 11, the nth EM circuit EMD-n may include a plurality of transistors and a capacitor connected to each other with respect to Q nodes Q_T1 and Q and a QB node QB.

As illustrated in FIG. 11, the nth EM circuit EMD-n may include first to fourth portions P1 to P4.

The first portion P1 may include T6 and T11 transistors and a CQ transistor. The first portion P1 may be supplied with the gate low voltage VEL and may be connected to the EM output terminal EMO.

The second portion P2 may include T1, T4, T10, and Tbv transistors. The EM start signal EVST or the emission control signal EM(n) of the front end, the gate low voltage VEL, and the second EM clock signal ECLK2 may be supplied to the first portion P1.

The third portion P3 may include T2, T3, T8, T9, and Tbv transistors and a CQ' capacitor. The first EM clock signal ECLK1 and the gate high voltage VEH may be supplied to the third portion P3.

The fourth portion P4 may include T5 and T7 transistors and a CQB capacitor. The gate high voltage VEH may be supplied to the fourth portion P4, and the EM output terminal EMO may be connected to the fourth portion P4.

Such an nth EM circuit EMD-n may generate an nth emission control signal EM(n) through the first to fourth portions P1 to P4 and may supply the nth emission control signal EM(n) to an nth line of the third gate line GL3. Therefore, the nth EM circuit EMD-n may supply the nth emission control signal EM(n) to a plurality of subpixels PXL connected to the nth line GL31 of the third gate line GL3 among the plurality of subpixels PXL disposed in the plurality of pixel areas AP.

The first to fourth portions P1 to P4 of the nth EM circuit EMD-n, as illustrated in FIG. 12, may be distributed and disposed in, for example, a plurality of third circuit areas AG31 to AG34.

In FIG. 12, it is illustrated that the plurality of third gate lines GL31 to GL34 extend in the first direction x and overlap the plurality of pixel areas AP and the plurality of third circuit areas AG3 and the plurality of first and second gate lines GL11 to GL14 and GL21 to GL24 do not extend in the first direction x. This may be for convenience of understanding, and the plurality of first and second gate lines GL11 to GL14 and GL21 to GL24 may extend in the first direction x in each of the rows R1 to R4 and may overlap the plurality of pixel areas AP and the plurality of first circuit areas AG11 to AG14. Also, in FIG. 12, the nth line of the third gate line GL3 is referred to by GL31.

For example, in the nth EM circuit EMD-n illustrated in FIG. 12, the first portion P1 may be disposed in a third-1 circuit area AG31 of FIG. 12, the second portion P2 may be disposed in a third-2 circuit area AG32, the third portion P3 may be disposed in a third-3 circuit area AG33, and the fourth portion P4 may be disposed in a third-4 circuit area AG34.

The gate low voltage VEL to be supplied to the first portion P1 may be supplied to a plurality of line lines extending in the second direction y in the third-1 circuit area AG31. Furthermore, depending on the case, the gate high voltage VEH may be further supplied to a line extending in the second direction y.

The EM start signal EVST or the emission control signal EM(n-1) of the front end, the gate low voltage VEL, and the second EM clock signal ECLK2, which are to be supplied to the second portion P2, may be supplied to a plurality of line lines extending in the second direction y in the third-2 circuit area AG32.

The first EM clock signal ECLK1 and the gate high voltage VEH, which are to be supplied to the second portion P2, may be supplied to a plurality of line lines extending in the second direction y in the third-3 circuit area AG33. Furthermore, depending on the case, the gate low voltage VEL may be further supplied to a line extending in the second direction y.

The gate high voltage VEH supplied to the fourth portion P4 may be supplied to a plurality of line lines extending in the second direction y in the third-4 circuit area AG34. Furthermore, depending on the case, the high-level driving voltage VDD to be supplied to the subpixel PXL of the pixel area AP may be additionally supplied to a line extending in the second direction y.

The EM output terminal EMO of the nth EM circuit EMD-n may be connected to the first portion P1 and the fourth portion P4 in common and may be connected to the nth third gate line GL31, and thus, at a point at which the third-1 circuit area AG31 and the third-4 circuit area AG34 intersects with the nth third gate line GL31 of the nth row Rn, the EM output terminal EMO of the nth EM circuit EMD-n may be connected thereto.

Furthermore, the plurality of subpixels PXL arranged in the pixel area AP of the first row R1 may be connected to the nth third gate line GL31 and may be supplied with the emission control signal EM(n) of the nth EM circuit EMD-n through the nth third gate line GL31.

Moreover, for example, as illustrated in FIG. 12, in the nth EM circuit EMD-n of FIG. 11, the Q_T1 node which is connected to the second portion P2, the third portion P3, and the fourth portion P4 of the nth EM circuit EMD-n may be implemented as a Q_T1 line extending in the first direction x and overlapping the subpixel PXL disposed in the pixel area AP. As illustrated in FIG. 12, the Q_T1 line may contact the third-2 circuit area AG32, the third-3 circuit area AG33, and the third-4 circuit area AG34.

Furthermore, for example, as illustrated in FIG. 12, in the nth EM circuit EMD-n of FIG. 11, the Q node which is connected to the first portion P1 and the second portion P2 in common may be implemented as a Q line extending in the first direction x and overlapping the subpixel PXL disposed in the pixel area AP. As illustrated in FIG. 12, the Q line may contact the third-1 circuit area AG31 and the third-2 circuit area AG32.

Furthermore, for example, as illustrated in FIG. 12, in the nth EM circuit EMD-n of FIG. 11, the QB node which is connected to the third portion P3 and the fourth portion P4 in common may be implemented as a QB line extending in the first direction x and overlapping the subpixel PXL disposed in the pixel area AP. As illustrated in FIG. 12, the QB line may contact the third-3 circuit area AG3 and the third-4 circuit area AG34.

As described above, the nth EM circuit EMD-n according to one or more embodiments of the present disclosure, which includes a plurality of driving elements such as a plurality of transistors and a capacitor, may be distributed and disposed in the plurality of third circuit areas AG31 to AG34. Lines such as the Q_T1 line and the QB line, which connect the plurality of driving elements with each other, may extend in the first direction x and may overlap the subpixels PXL.

Moreover, although not illustrated in FIG. 12, the plurality of first and second gate lines GL11 to GL14 and GL21 to GL24 may extend onto the third circuit areas AG31 to AG34 and may overlap the plurality of third circuit areas AG31 to AG34. However, the plurality of first and second gate lines GL11 to GL14 and GL21 to GL24 may not be electrically connected to the plurality of third circuit areas AG31 to AG34. However, the plurality of first and second gate lines GL11 to GL14 and GL21 to GL24 may be connected to the plurality of subpixels PXL arranged between the plurality of third circuit areas AG31 to AG34.

Moreover, as illustrated in FIG. 12, the GL32 to GL34 lines of the third gate line GL3 may extend and overlap the nth EM circuit EMD-n, but the GL32 to GL34 lines of the third gate line GL3 are not connected to the nth EM scan circuit and may be connected to the plurality of subpixels PXL arranged in the pixel areas AP of the second to fourth rows R2 to R4.

The GL32 to GL34 lines of the third gate line GL3 may receive emission control signals EM(n+1) to EM(n+3) supplied from an EM circuit EMD other than the nth EM circuit EMD-n in the EM block BEM.

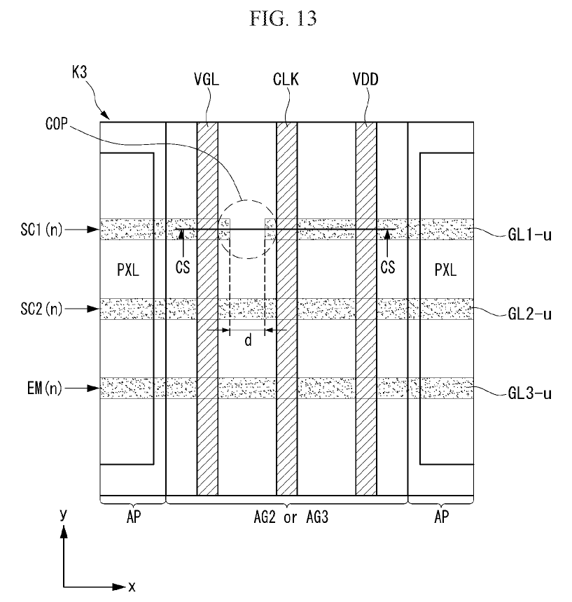

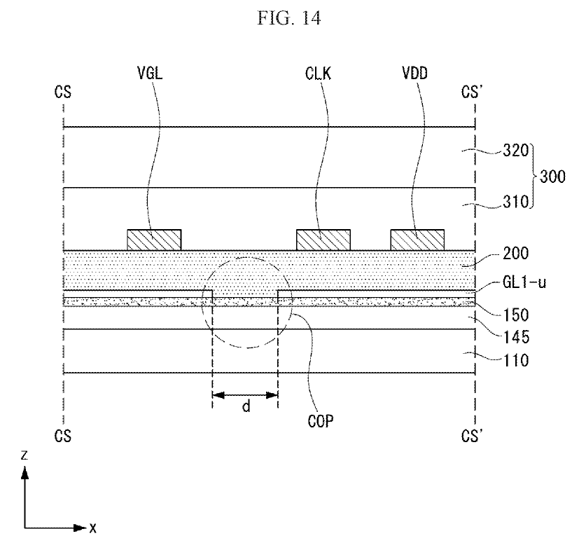

FIG. 13 is an enlarged view of a K4 portion in FIG. 8, and FIG. 14 is a cross-sectional view illustrating a cross-sectional surface taken along line CS-CS' in FIG. 13.

As illustrated in FIG. 13, the first upper gate line GL1-u may include an open circuit portion COP at a portion adjacent to inclined surfaces NC-S2a and NC-S2b of the notch area NC. An end of the first upper gate line GL1-u which is open-circuited by the open circuit portion COP may be spaced apart from each other in the first direction x.

The open circuit portion COP of the first upper gate line GL1-u may be disposed in one of the other circuit areas AG except the first circuit area AG1 among the plural circuit areas AG. For example, the open circuit portion COP of the first upper gate line GL1-u may be disposed to overlap one of the second circuit area AG2 or the third circuit area AG3.

A pixel area AP where subpixels PXL are disposed may be disposed on both side surfaces of one circuit area, and the first upper gate line GL1-u, the second upper gate line GL2-u, and the third upper gate line GL3-u may overlap the subpixel PXL.

However, the second upper gate line GL2-u and the third upper gate line GL3-u may not include an open circuit portion COP in an area adjacent to the inclined surfaces NC-S2a and NC-S2b of the notch area NC. However, embodiments of the present disclosure are not limited thereto, and depending on the case, like the first upper gate line GL1-u, the second and third upper gate lines GL2-u and GL3-u may be possible to include an open circuit portion COP at a portion adjacent to the included surfaces NC-S2a and NC-S2b of the notch area NC.

In FIG. 13, it is illustrated that a width d of the open circuit portion COP is less than an interval between lines through which the gate low voltage VEL, the clock signal CLK, or the high-level driving voltage VDD is transferred, in the second circuit area AG2 or the third circuit area AG3, but embodiments of the present disclosure are not limited thereto and the width d of the open circuit portion COP may be possible to be greater than an interval between lines disposed in the circuit area AG.

As illustrated in FIG. 14, in the second circuit area AG2 or the third circuit area AG3, the first upper gate line GL1-u may extend in the first direction x on the gate insulation layer 150, the open circuit portion COP may be disposed on the gate insulation layer 150, and an open-circuited end of the first upper gate line GL1-u may be covered by the interlayer insulation layer 200.

Therefore, both ends of the first upper gate line GL1-u spaced apart from each other by the open circuit portion COP may be insulated from each other by the interlayer insulation layer 200.

Lines, which extend in the second direction y from the second circuit area AG2 or the third circuit area AG3 and receive the gate row voltage VEL, the clock signal CLK, or the high-level driving voltage VDD, may be disposed between the interlayer insulation layer 200 and the planarization layer 300.

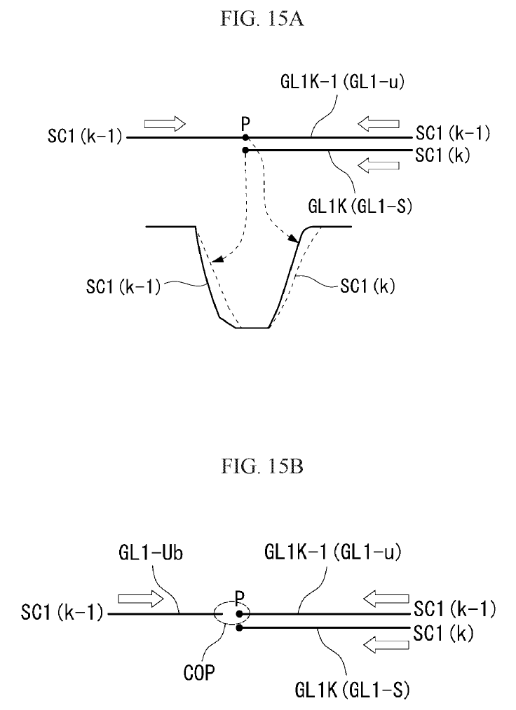

FIGS. 15A and 15B are diagrams for describing an effect based on an open circuit portion.

As described above, when the open circuit portion COP is provided in the first upper gate line GL1-u so as to be adjacent to a portion contacting each of the top surface NC-S1 and the inclined surfaces NC-S2a and NC-S2b of the notch area NC, output characteristics of the first scan signal SC1(n) supplied to the first upper gate line GL1-u and the first scan signal SC1(n) supplied to the first side gate line GL1-s may be adjusted to be almost equal to each other, and thus, luminance in a side area and an upper area of the notch area NC may be adjusted to be almost equal to each other, thereby more improving image quality.

In detail, in FIG. 15A, a GL1k-1 line may be one of the first upper gate lines GL1-u, and a GL1k line may be one of the first side gate lines GL1-s. A P point of the first upper gate line GL1-u and the first side gate line GL1-s may be a point which is disposed adjacent to a point contacting each of the top surface NC-S1 and the inclined surfaces NC-S2a and NC-S2b of the notch area NC. The first and second blocks B1 and B2 of the first scan block BSC1 described above with reference to FIG. 8 may be disposed at both sides of the P point. The P point may be a middle point of the first scan circuit SCN1 disposed in each of the first and second blocks B1 and B2.

As illustrated in FIG. 15A, when the open circuit portion COP is not provided on the first upper gate line GL1-u, a first scan signal SC1(k-1) may be supplied from both sides of the first and second blocks B1 and B2 to the GLlk-1 line disposed on the notch area NC, but the GLlk line disposed on a side surface of the notch area NC may receive the first scan signal SC1(k) from the second block B2 except the first block B1.

Therefore, an output characteristic of the first scan signal SC1(k-1) at the P point and an output characteristic of the first scan signal SC1(k) at the P point may differ.

That is, the first scan signal SC1(k-1) supplied to the P point may be double-fed from the first and second blocks B1 and B2 of the first scan block BSC1. Therefore, the voltage drop and rising speed of the first scan signal SC1(k-1) may be relatively greater than those of the first scan signal SC1(k).

Accordingly, a driving current of a subpixel PXL disposed in a side area of the notch area NC may differ from a driving current of a subpixel PXL disposed in an upper area, causing a luminance deviation. Due to this, image quality may be degraded.

However, as illustrated in FIG. 15B, when the first upper gate line GL1-u includes the open circuit portion COP at the P point, an output characteristic difference between the first scan signal SC1(k-1) and the first scan signal SC1(k) may be reduced at the P point, and thus, a driving current deviation and a luminance deviation may be reduced, thereby more improving image quality.

As described above, when a display panel includes a notch area, embodiments of the present disclosure may include an open circuit portion where a portion of a first upper gate line is open-circuited, and thus, may improve a luminance deviation between a side surface and an upper portion of the notch area in an active area, thereby enhancing the quality of a display screen.

The effects according to the present disclosure are not limited to the above examples, and other various effects may be included in the disclosure.

While the present disclosure has been particularly shown and described with reference to embodiments thereof, it will be understood by those of ordinary skill in the art that various changes in form and details may be made therein without departing from the spirit and scope of the present disclosure as defined by the following claims.

What is claimed is:

1. A display panel, comprising:
an active area including a plurality of pixel areas arranged spaced apart from each other in a first direction and a plurality of circuit areas arranged between the plurality of pixel areas;
a subpixel disposed in each of the plurality of pixel areas and configured to receive a data voltage to allow a light-emitting device to emit light, based on a first scan signal supplied through a first gate line of a plurality of first gate lines extending in the first direction; and
a plurality of first scan blocks distributed and disposed in the active area, each of the plurality of first scan blocks including a first scan circuit disposed in a plurality of first circuit areas among the plurality of circuit areas and configured to generate the first scan signal to supply the first scan signal to the first gate line,
wherein the active area comprises a notch area where a portion thereof is recessed in a second direction intersecting with the first direction,
wherein the plurality of first gate lines comprise a plurality of first side gate lines disposed on a side surface of the notch area in the first direction and a plurality of first upper gate lines disposed on the notch area in the second direction, each of the plurality of first side gate lines including an end contacting the notch area, and
wherein the plurality of first upper gate lines comprise a plurality of open circuit portions where a portion of a first upper gate line of the plurality of first upper gate lines is disconnected and opened.

2. The display panel of claim 1, wherein the notch area comprises a top surface extending in the first direction and an inclined surface inclined in a direction intersecting with the first direction and the second direction at an end of the top surface, and
wherein the plurality of open circuit portions included in the plurality of first upper gate lines are disposed adjacent to a portion contacting each of the top surface and the inclined surface.

3. The display panel of claim 2, wherein the plurality of first scan blocks comprise a first block and a second block spaced apart from each other in the first direction and extending in the second direction,
wherein the first block comprises an extension portion disposed on the top surface,
wherein the second block comprises an extension portion disposed on the inclined surface or disposed outside the inclined surface, and
wherein the plurality of open circuit portions are disposed between the first block and the second block.

4. The display panel of claim 3, wherein each of the first block and the second block comprise:
a first-1 scan circuit configured to supply the first scan signal to a first line of the first upper gate line; and
a first-2 scan circuit disposed adjacent to the first-1 scan circuit in the first direction and configured to supply the first scan signal to a second line of the first upper gate line.

5. The display panel of claim 4, wherein the plurality of open circuit portions comprise a first open circuit portion and a second open circuit portion,
wherein the first open circuit portion is disposed on the first line, between first-1 scan circuits of the first block and the second block, and
wherein the second open circuit portion is disposed on the second line, between first-2 scan circuits of the first block and the second block.

6. The display panel of claim 5, wherein a first length up to the first open circuit portion from an output terminal of the first-1 scan circuit of the first block is equal to a second length up to the first open circuit portion from an output terminal of the first-1 scan circuit of the second block, and
wherein a third length up to the second open circuit portion from an output terminal of the first-2 scan circuit of the first block is equal to a fourth length up to the second open circuit portion from an output terminal of the first-2 scan circuit of the second block.

7. The display panel of claim 5, wherein, in the first line, a number of subpixels or pixel areas disposed between the first open circuit portion and an output terminal of the first-1 scan circuit of the first block is equal to a number of subpixels or pixel areas disposed between the first open circuit portion and an output terminal of the first-1 scan circuit of the second block, and
wherein, in the second line, a number of subpixels or pixel areas disposed between the second open circuit portion and an output terminal of the first-2 scan circuit of the first block is equal to a number of subpixels or pixel areas disposed between the second open circuit portion and an output terminal of the first-2 scan circuit of the second block.

8. The display panel of claim 5, wherein the first open circuit portion and the second open circuit portion are spaced apart from each other in the first direction.

9. The display panel of claim 3, wherein some first scan circuits, disposed on a side surface of the notch area among a plurality of first scan circuits disposed in the second block, supply the first scan signal to a first side gate line of the plurality of first side gate lines.

10. The display panel of claim 3, wherein the plurality of first circuit areas and the plurality of pixel areas are alternately arranged in each of the first block and the second block, and
wherein each of a first-1 scan circuit and a first-2 scan circuit is distributed and disposed in the plurality of first circuit areas.

11. The display panel of claim 1, wherein the subpixel comprises:
a semiconductor layer disposed on a buffer layer on a substrate;
a gate insulation layer covering the buffer layer and disposed on the semiconductor layer;
a gate electrode disposed on the gate insulation layer and overlapping the semiconductor layer;
an interlayer insulation layer disposed on the gate insulation layer and covering the gate electrode;
a source electrode and a drain electrode disposed on the interlayer insulation layer and connected to the semiconductor layer;
a planarization layer disposed on the interlayer insulation layer and covering the source electrode and the drain electrode; and
a first electrode disposed on the planarization layer, the first electrode connected to one of the source electrode and the drain electrode, and the first electrode included in the light-emitting device.

12. The display panel of claim 11, wherein the first upper gate line extends in the first direction on the gate insulation layer, and an open circuit portion of the plurality of open circuit portions is disposed on the gate insulation layer.

13. The display panel of claim 1, wherein the plurality of open circuit portions are disposed in one of other circuit areas except a first circuit area among the plurality of circuit areas.

14. The display panel of claim 1, wherein the subpixel is further connected to a second gate line of a plurality of second gate lines extending in the first direction and receiving a second scan signal controlling supply of a reference voltage,
wherein the subpixel further comprises a plurality of second scan blocks distributed and disposed between the plurality of first scan blocks in the active area, disposed in a plurality of second circuit areas except a first circuit area among the plurality of circuit areas, and each of the plurality of second scan blocks including a second scan circuit configured to generate the second scan signal and supply the second scan signal to the second gate line,
wherein the plurality of second gate lines comprise a plurality of second side gate lines disposed on a side surface of the notch area in the first direction and a plurality of second upper gate lines disposed on the notch area in the second direction, each of the plurality of second side gate lines including an end contacting the notch area, and
wherein an open circuit portion of the plurality of open circuit portions is not positioned in a portion of a second upper gate line of the plurality of second upper gate lines that is adjacent to an inclined surface of the notch area.

15. The display panel of claim 1, wherein the subpixel is further connected to a third gate line of a plurality of third gate lines extending in the first direction and receiving an emission control signal controlling whether to allow the light-emitting device to emit light,
wherein the subpixel further comprises a plurality of EM blocks distributed and disposed between the plurality of first scan blocks and a plurality of second scan blocks in the active area, disposed in a plurality of third circuit areas except first and second circuit areas among the plurality of circuit areas, each of the plurality of EM blocks including an EM circuit configured to generate the emission control signal and supply the emission control signal to the third gate line,
wherein the plurality of third gate lines comprise a plurality of third side gate lines disposed on a side surface of the notch area in the first direction and a plurality of third upper gate lines disposed on the notch area in the second direction, each of the plurality of third side gate lines including an end contacting the notch area, and
wherein an open circuit portion of the plurality of open circuit portions is not positioned in a portion of a third upper gate line of the plurality of third upper gate lines that is adjacent to an inclined surface of the notch area.

16. A display apparatus, comprising:
an active area including a plurality of pixel areas arranged spaced apart from each other in a first direction and a plurality of circuit areas arranged between the plurality of pixel areas;
a subpixel disposed in each of the plurality of pixel areas and configured to receive a data voltage to allow a light-emitting device to emit light, based on a first scan signal supplied through a first gate line of a plurality of first gate lines extending in the first direction; and
a plurality of first scan blocks distributed and disposed in the active area, each of the plurality of first scan blocks including a first scan circuit disposed in a plurality of first circuit areas among the plurality of circuit areas and configured to generate the first scan signal to supply the first scan signal to the first gate line,
wherein the active area comprises a notch area where a portion of the active area is recessed in a second direction intersecting with the first direction,
wherein the plurality of first gate lines comprise a plurality of first side gate lines disposed on a side surface of the notch area in the first direction a plurality of first upper gate lines disposed on the notch area in the second direction, each of the plurality of first side gate lines including an end contacting the notch area and,
wherein each of the plurality of first upper gate lines comprises a plurality of open circuit portions where a portion of a first upper gate line of the plurality of first upper gate lines is disconnected and opened, and
wherein open-circuited ends of the first upper gate line are spaced apart from each other in the first direction.
